(19) United States
(12) Patent Application Publication
(10) Pub. No.: US 2022/0308841 A1
(43) Pub. Date: Sep. 29, 2022

(54) ENABLING CUSTOM SOFTWARE DEVELOPMENT BY DOMAIN EXPERTS

(71) Applicant: Clearwater Analytics, LLC, Boise, ID (US)

(72) Inventors: Kaitlyn Ella Coil, Boise, ID (US); Jason Roy Mauzey, Boise, ID (US); Michael Scott Ritthaler, Boise, ID (US); Gary Grant Johnson, Eagle, ID (US); Steven Lewis Raeder, Boise, ID (US); Dana Jo Salk, Meridian, ID (US); Douglas Gregory Hamilton, Boise, ID (US)

(21) Appl. No.: 17/212,883

(22) Filed: Mar. 25, 2021

(51) Int. Cl. G06F 8/30

(52) U.S. Cl. CPC G06F 8/30

(57) ABSTRACT

A facility for creating custom software to analyze resource data is configured to assist domain experts in the creation of custom software. The facility obtains user input indicating one or more global inputs and one or more global outputs. The facility obtains user input creating one or more nodes, each having one or more inputs and one or more outputs, and each configured to evaluate resource data based on the inputs to produce the outputs. The facility obtains user input mapping between outputs and inputs of nodes to establish a network among the nodes. The facility evaluates each node in accordance with the established network based on the global inputs and global outputs. The facility displays the nodes and the network among the nodes.

### BACKGROUND

An organization typically owns a large number of resources. Expert knowledge regarding the assets is generally required to analyze and keep track of these resources. Additionally, analysis of resource use, status, etc., especially for a large organization, involves accessing and interpreting large amounts of data describing each resource. In order to perform this analysis, custom software programs are typically developed to process and interpret data describing the resources.

### BRIEF DESCRIPTION OF THE DRAWINGS

FIG. 1 is a block diagram showing some of the components typically incorporated in at least some of the computer systems and other devices on which the facility operates.

FIG. 2 is a table diagram showing sample contents of a node data table used by the facility in some embodiments.

FIG. 3 is a flow diagram showing a process to create custom software, performed by the facility in some embodiments.

FIG. 4 is a display diagram showing a sample add node screen, presented by the facility in some embodiments.

FIG. 5 is a display diagram showing a sample edit node screen, used by the facility in some embodiments.

FIG. 6 is a display diagram showing a sample add node from output screen, presented by the facility in some embodiments.

FIG. 7 is a display diagram showing an edit addition node screen, presented by the facility in some embodiments.

FIG. 8 is a display diagram showing an add curve node screen, presented by the facility in some embodiments.

FIG. 9 is a display diagram showing an add market price node screen, presented by the facility in some embodiments.

FIG. 10 is a display diagram showing an add custom node screen, presented by the facility in some embodiments.

FIG. 11 is a display diagram showing an add concatenate curve node screen, presented by the facility in some embodiments.

FIG. 12 is a table diagram showing a custom software definition table used by the facility in some embodiments.

FIG. 13 is a flow diagram showing a process to create custom software with stages, performed by the facility in some embodiments.

FIG. 14 is a display diagram showing a custom software definition screen, presented by the facility in some embodiments.

FIG. 15 is a display diagram showing a custom software diagram screen, presented by the facility in some embodiments.

FIG. 16 is a display diagram showing an output definition screen, presented by the facility in some embodiments.

FIG. 17 is a display diagram showing an add interface node screen, presented by the facility in some embodiments.

FIG. 18 is a display diagram showing a define interface node screen, presented by the facility in some embodiments.

FIG. 19 is a display diagram showing a node grouping screen, presented by the facility in some embodiments.

FIG. 20 is a display diagram showing a parent node screen, presented by the facility in some embodiments.

FIG. 21 is a flow diagram showing a process to create custom nodes, used by the facility in some embodiments.

### DETAILED DESCRIPTION

The inventors have recognized that it would be of great benefit to domain experts to be able to independently and easily create custom software for processing and interpreting data describing resources, without requiring any coding knowledge or experience.

Currently, in order to create custom software for processing and interpreting data describing resources, domain experts must work with software developers or learn to code themselves. The inventors have recognized a variety of disadvantages to current methods of creating custom software for analyzing resource use, status, etc. First, the domain experts must work directly with software developers in order to create the software, imposing the requirement that they communicate effectively. Additionally, both the domain expert and the software developer will need to spend time and resources in order to debug and test the software. Domain experts and software developers are also unable to immediately test the software, as the software must to be compiled in order to be used. Also, domain experts would be required to learn how to code in order to create the software if they are unable to work with a software developer.

In response to recognizing these disadvantages, the inventors have conceived and reduced to practice a software and/or hardware facility for creating custom software for analyzing resource use, status, etc. (“the facility”). The facility enables a domain expert (a “user”) to create customized software for manipulating, analyzing, and displaying resource data without coding experience or knowledge. The facility additionally allows a user to decompose the analysis into distinct phases and to manipulate unconventional data types, such as by using time series data, curves, etc., as inputs and outputs.

In some embodiments, the facility accesses input data from within a repository of resource data. In some embodiments, the facility is able to pull data from sources other than the repository of resource data. In some embodiments, the facility allows users to select which data sources the facility should pull data from.

In some embodiments, the facility displays a user interface which allows a user to create nodes that each access and manipulate data. In some embodiments, the user interface is used to create a visual graph of nodes. In the graph, a node receives inputs, some or all of which can come from the outputs of other nodes or external data sources. In some embodiments, the user interface allows a user to map output from one node into input from another node. In some embodiments, the facility automatically maps output from one node into input from another node.

A node typically performs calculations or other processing on its inputs to determine its output. In some embodiments, a node displays its output. In some embodiments, a node determines the output in real-time as inputs are added or removed from the node. In some embodiments, a node is able to manipulate a multitude of data types, such as integers, decimals, strings, time-series data, curves, etc. In some embodiments, a node can generate a file, such as a spreadsheet, log file, etc., containing the output.

In some embodiments, a node itself can contain multiple nodes, which a user can manipulate. In some embodiments, the facility allows a user to create customized nodes. In some embodiments, the customized nodes may contain multiple nodes. In some embodiments, a customized node evaluates a function created by a user using a coding language, such as Python, Java, JavaScript, C, C++, etc. In some embodiments, the language in which the facility is written does not always have to match the language in which the custom node function is written, provided that there is a method for interoperability between the languages. For example, the facility may be based in Clojure, but the customized node may be in Python.

By performing in some or all of the ways described above, the facility allows a user to create custom resource analysis software. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. The facility additionally improves the development of custom resource analysis software by automatically configuring the transmission of data between steps in the analysis and providing reusable functionality that can be integrated in multiple, different instances of the software, thereby enabling more rapid development of the analysis software. For example, by utilizing previously-created nodes and existing resource data, a domain expert is able to design, create, debug, and validate customized software for analyzing resource data without the need to compile the software after it is completed, thereby utilizing less processing power and memory to analyze resource data as well as reducing the time it takes to deliver new functionality into a system when following a traditional software development lifecycle.

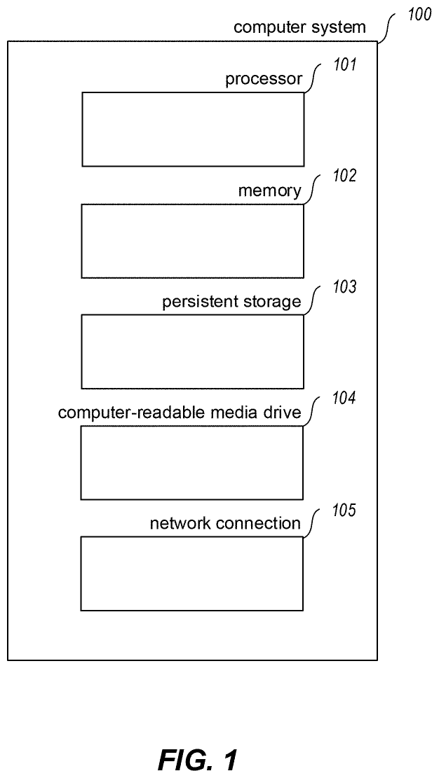

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include one or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer- readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

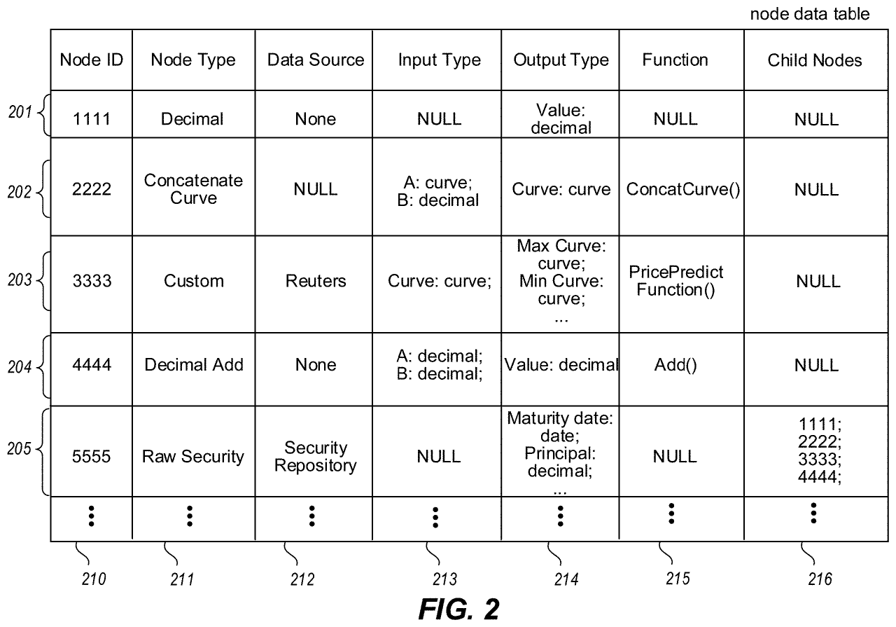

FIG. 2 is a table diagram showing sample contents of a node data table 200 used by the facility in some embodiments. The node data table 200 stores information describing a particular graph of nodes constructed to perform a particular set of operations on data, by describing each of the nodes that occurs in in the visual graph of nodes, including their type, data source, input and output types, etc. The node data table 200 contains rows, such as rows 201-205, each corresponding to a different node that occurs in the network of nodes. Each row is divided into the following columns: a node id column 210, a node type column 211, a data source column 212, an input type column 213, an output type column 214, a function column 215, and a child nodes column 216. The node id column 210 stores a unique identifier used to identify a node from other nodes. The node type column 211 stores data specifying a node's type. In some embodiments, the facility uses one or more pre-defined node types, such as “Decimal”, “Concatenate Curve”, “Decimal Add”, etc., which are used to indicate to the facility and to a user what calculations, data analysis, data manipulation, etc., are performed by the node. In some embodiments, a “Custom” node type indicates that the node is a customized node with functionality defined by a user. The data source column 212 stores data indicating a data source for the node. In some embodiments, the data source column 212 includes an indication of a data source obtained from a user. In some embodiments, the data source is a repository of resource data included in the facility. In some embodiments, the data source is external to the facility, and the facility obtains data from this external data source. In some embodiments, a node has more than one data source (not shown).

The input type column 213 stores data indicating data types for the node's inputs. The output type column 214 stores data indicating data types for the node's outputs. In some embodiments, the input type column 213 and the output type column 214 can include input types such as curve, time-series data, etc. in addition to traditional types such as decimal, integer, date, time, etc. The function column 215 stores an indication of a function performed by the node. In some embodiments, a function is predefined by the facility based on the node's type, for example a “Decimal Add” node may use an “Add( )” function. In some embodiments, a user can specify a customized function for a node. The child nodes column 216 stores data indicating which nodes are child nodes of the node. In some embodiments, the facility stores data indicating the parent node of a node in the node data table 200 (not shown).

The facility utilizes the node data table 200 to store data corresponding to different nodes. For example, row 201 represents a decimal node, as indicated by the node type column 211, which has no data source, indicated by data source column 212, no input type, as indicated by the input type column 213, an output named “Value” which is a decimal, as indicated by the output type column 214, and no function or child nodes as indicated by the function column 215 and child nodes column 216 respectively. Row 202 represents a concatenate curve node, with no data source, two inputs “A” and “B” which are typed as a curve and a decimal respectively, one output named “Curve” which is a curve, no child nodes, and which utilizes the ConcatCurve( ) function. Row 203 represents a custom node, which has “Reuters” as a data source, an input, “Curve”, with an input type of curve, at least two outputs, including “Max Curve” and “Min Curve” each having a type of curve, and which utilizes the “PricePredictFunction( )”. Row 205 is a raw security node, which specifies the “Security Repository” (a resource data repository included in the facility) as a data source, outputs of at least a “Maturity date” and “Principal” which are typed as a date and a decimal respectively, and four child nodes as indicated by the child nodes column 216.

While FIG. 2 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner;

may contain more or less information than shown; may be compressed, encrypted, and/or indexed; may contain a much larger number of rows than shown, etc.

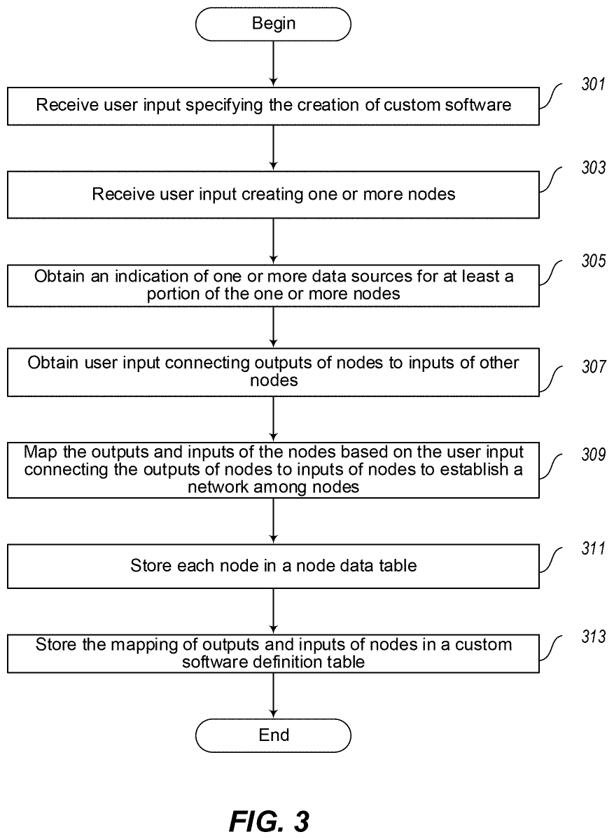

FIG. 3 is a flow diagram showing a process to create custom software, performed by the facility in some embodiments. In act 301, the facility receives user input specifying the creation of custom software. In act 303, the facility receives user input creating one or more nodes. In some embodiments, the facility performs act 303 by displaying an add node screen to the user.

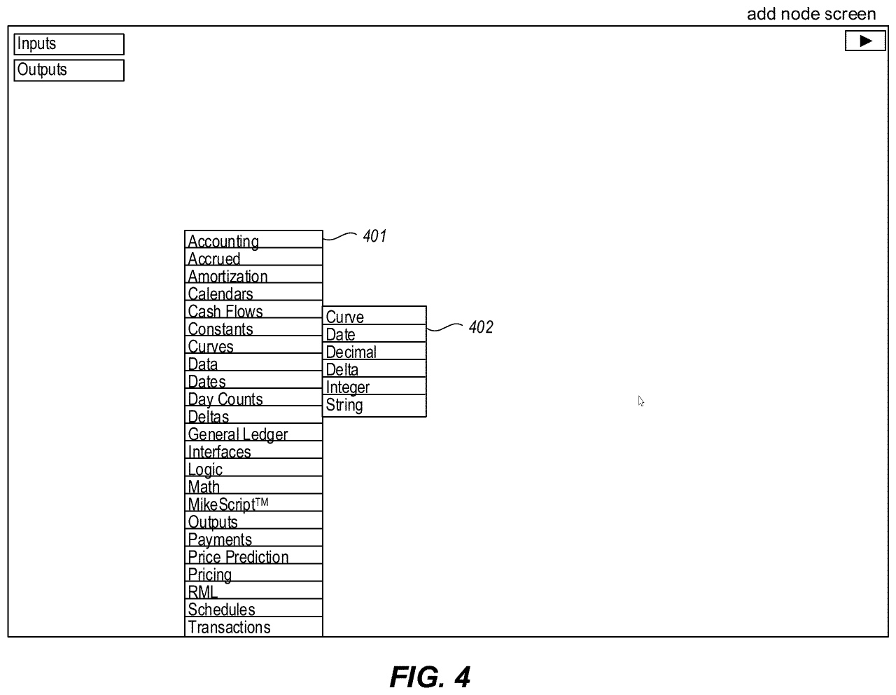

FIGS. 4-11 show a variety of sample screens presented by the facility to obtain user input to create custom software. FIG. 4 is a display diagram showing a sample add node screen, presented by the facility in some embodiments. The add node screen includes a node group dropdown 401 and a node type dropdown 402. The node group dropdown 401 includes one or more node groups to choose from, such as accounting nodes, calendar nodes, logic nodes, math nodes, data nodes, constant nodes, etc. Each of the node groups included in the node group dropdown 401 represent different groups of nodes based on their functionality, such as constant nodes for representing a constant variable, math nodes for representing math operations, etc. In some embodiments, a user accesses the node group dropdown 401 by right-clicking an empty portion of the add node screen. The facility presents the node type dropdown 402 based on user interaction with a node group presented by the node group dropdown 401. The node type dropdown 402 indicates specific node types included in a node grouping. For example, the constants grouping includes curve nodes, date nodes, decimal nodes, etc. as indicated by the node type dropdown 402. After receiving user interaction indicating a node type, the facility displays a representation of the node and the user can edit the created node. In some embodiments, the facility presents an edit node screen after a node is created.

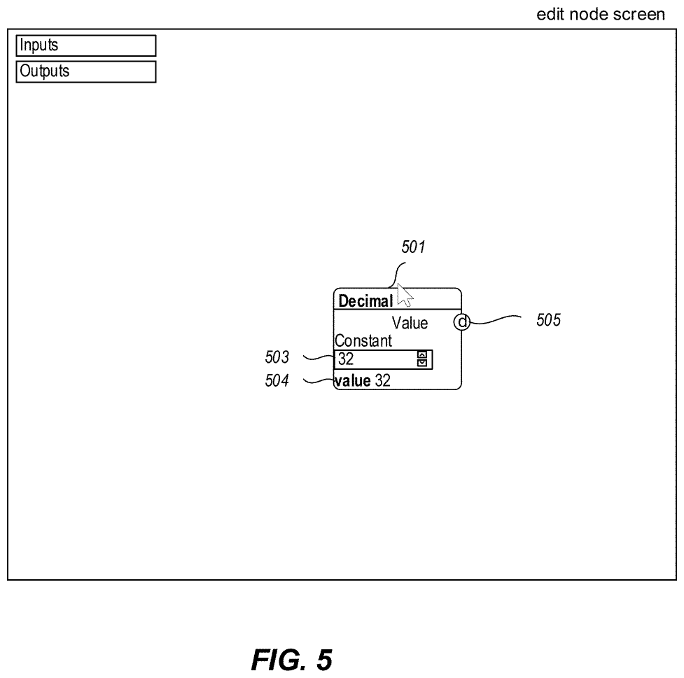

FIG. 5 is a display diagram showing a sample edit node screen, used by the facility in some embodiments. The edit node screen includes a node block 501 which includes a value input 503, an evaluation display 504, and an output 505. The node block 501 represents a decimal node with a constant value created by the facility. The facility displays node blocks to represent nodes created by a user. The value input 503 allows a user to input a constant value used by the node block. The evaluation display 504 indicates the value of the output when the facility evaluates the node. The output 505 allows a user to connect the node's output to another node's input, thereby signaling to the facility that the output of the node should be used as an input for the connected node. In some embodiments, the facility displays the data type of the output 505, for example the output 505 in FIG. 5 indicates that the data type is a “decimal” based on the “d” displayed in the output 505. In some embodiments, when the output 505 is activated and not connected to another node, the facility displays an add node from output screen.

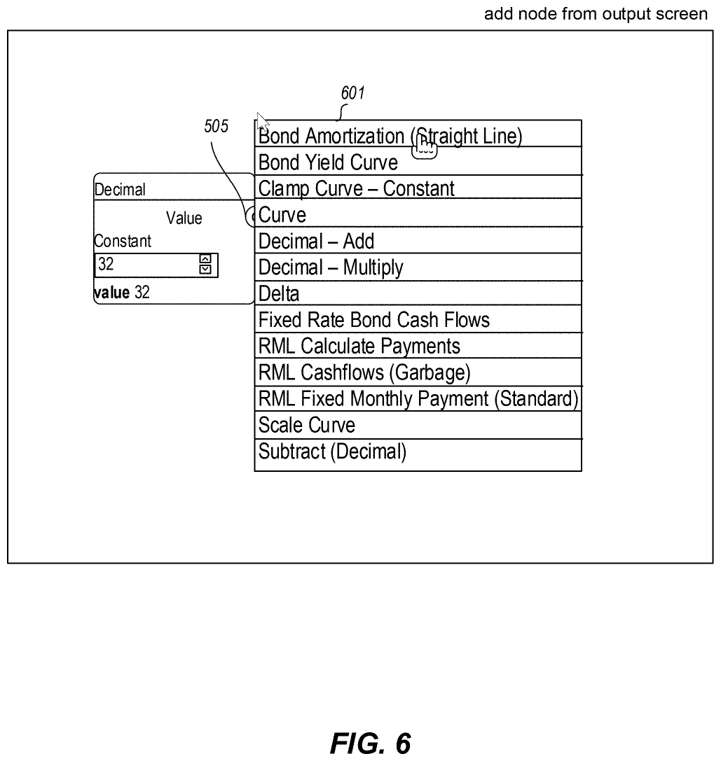

FIG. 6 is a display diagram showing a sample add node from output screen, presented by the facility in some embodiments. The add node from output screen includes a node list 601. The node list 601 includes a variety of node types which a user can select to add the node. When the node is added, the facility automatically connects the output 505 to an input of the node which matches the type of the output. In some embodiments, the node list 601 only includes nodes which can accept an input of the same type as the output 505. In some embodiments, after a user selects a node type from the node list 601, the facility presents a screen used to edit the node, such as an edit addition node screen.

Returning to FIG. 3, at act 305 the facility obtains an indication of one or more data sources for at least a portion of the one or more nodes. In some embodiments, the data source includes a repository of resource values. In some embodiments, the repository of resource values is a default data source. In some embodiments, the repository of resource values is maintained by the facility. In some embodiments, a data source for the one or more nodes includes external data sources. At act 307, the facility obtains user input connecting the outputs of nodes to inputs of other nodes. In some embodiments, the facility connects the outputs of nodes to inputs of other nodes based on the data types of the outputs and the data types of the inputs. In some embodiments, the facility performs acts 305 and 307 by using an edit addition node screen, or any of the other screens described in FIGS. 4-11.

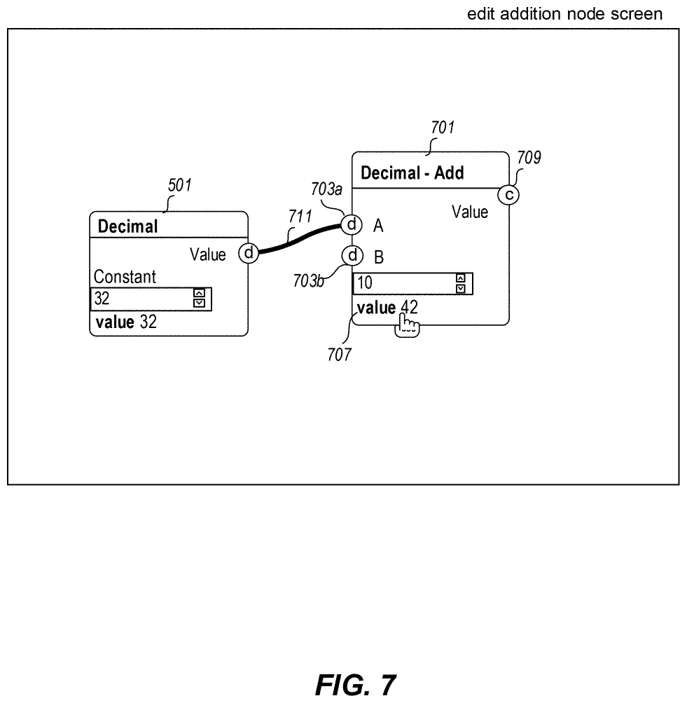

FIG. 7 is a display diagram showing an edit addition node screen, presented by the facility in some embodiments. The edit addition node includes an addition node block 701, which includes inputs 703a and 703b, an output 709, and an evaluation display 707, and a connection 711. The inputs 703a and 703b represent inputs for the node. Each of the inputs 703a and 703b may have their own type. Additionally, each of the inputs 703a and 703b may be connected to an output from another node. In some embodiments, the data type of the inputs 703a and 703b are displayed in a similar manner to the data type of the output 505 in FIG. 5. In some embodiments, the facility allows a user to enter a constant value or data source for an input, such as the input 703b having a constant value of “10” as seen in FIG. 7. The evaluation display 707 displays the value of the node after being evaluated. The output 709 operates in a similar manner to the output 505 of FIG. 5. The connection 711 illustrates that the value for input 703a is obtained from the output of the node block 501. For example, the addition node block 701 obtains the value “32” as input 703a from node block 501 and “10” as input 703b as a user-specified constant. The facility evaluates the addition node block 701 by using a function based on the node type of the node represented by the addition node block 701, and displays the value in the evaluation display 707. Additionally, the value can be output to another node by using the output 709.

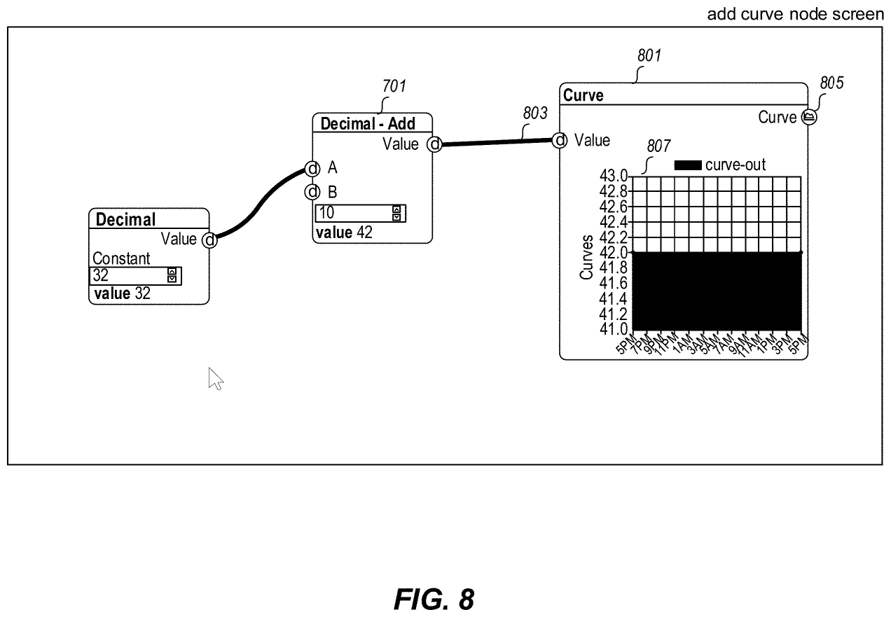

FIG. 8 is a display diagram showing an add curve node screen, presented by the facility in some embodiments. The facility presents the add curve node screen when it obtains input from a user that a curve node should be added. The add curve node screen includes a curve node block 801, which includes an output 805 and a graph 807, and a connection 803. The curve node block 801 is used to obtain a value, a set of values, time-series data, etc., to create a curve. The curve node block 801 represented in FIG. 8 obtains a decimal value as an input through connection 803 to the addition node block 701, and outputs a curve through the output 805. The facility displays the curve created from the input received through connection 803 by using the graph 807.

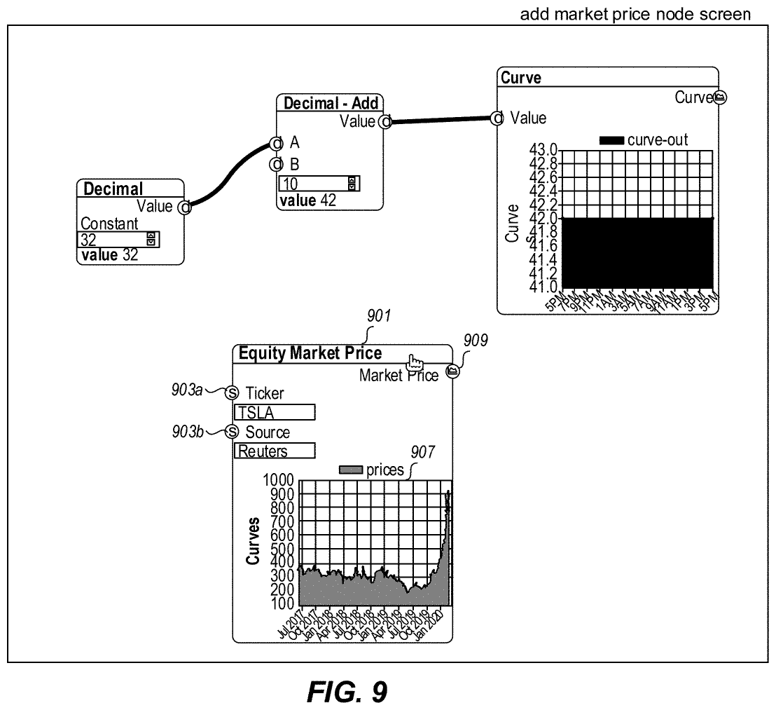

FIG. 9 is a display diagram showing an add market price node screen, presented by the facility in some embodiments. The add market price node screen includes a market price node block 901, which includes inputs 903a and 903b, graph 907, and output 909. The input 903a obtains user input indicating a ticker for a security traded on the stock market. The input 903b obtains user input indicating a source for data regarding the security specified in input 903a. The facility displays data related to the security, such as the market price over time, by using the graph 907. The output 909 outputs a curve representing the data regarding the security.

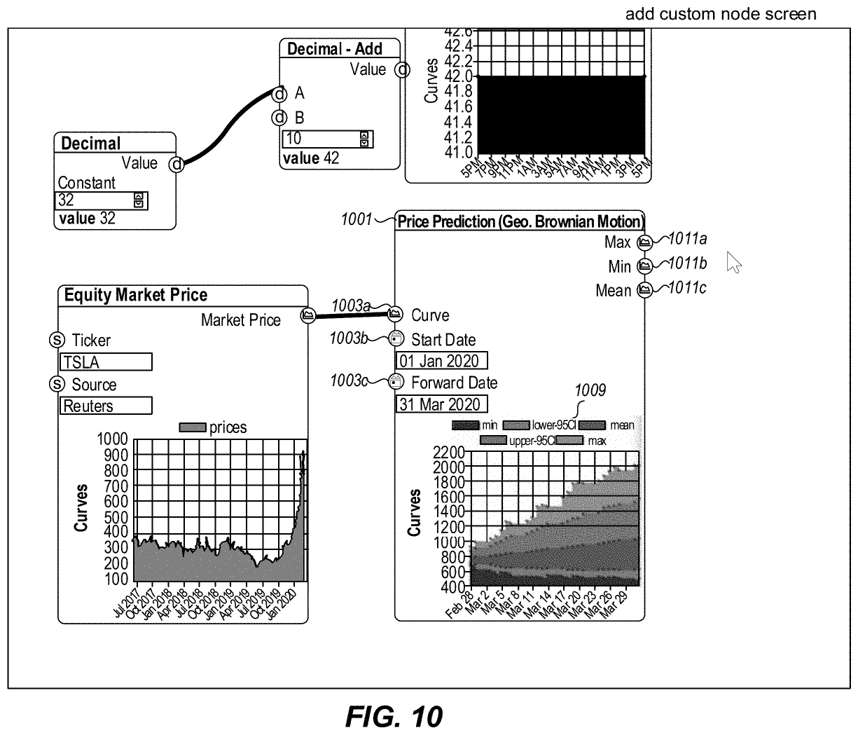

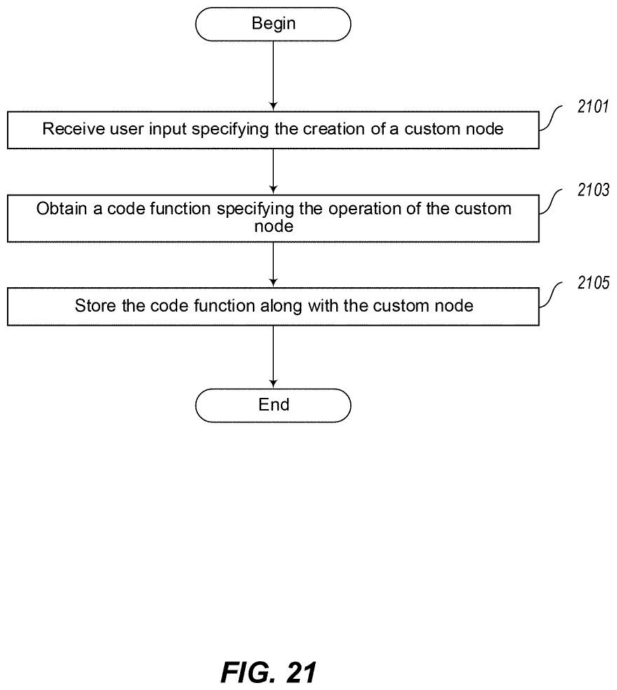

FIG. 10 is a display diagram showing an add custom node screen, presented by the facility in some embodiments. The add custom node screen includes a custom node block 1001, which includes inputs 1003a-1003c, a graph 1009, and outputs 1011a-1011c. The custom node block 1001 is a custom node created by a user to perform custom functionality. The custom node block 1001 depicted in FIG. 10 is used to simulate the price of a security over a period of time. The process of creating a custom node is further described in FIG. 21. The input 1003a obtains a curve as input. The inputs 1003b and 1003c each obtain dates as input, and can be specified directly by a user. The facility uses the custom functionality defined by the user to evaluate the inputs 1003a-1003c. For example, in FIG. 10, the facility utilizes the curve, start date, and forward date specified by inputs 1003a-1003c to simulate the price of the security. The graph 1009 displays a simulation of the price of the security based on the custom functionality and the inputs 1003a-1003c. The outputs 1011a-1011c each output curves based on the custom functionality.

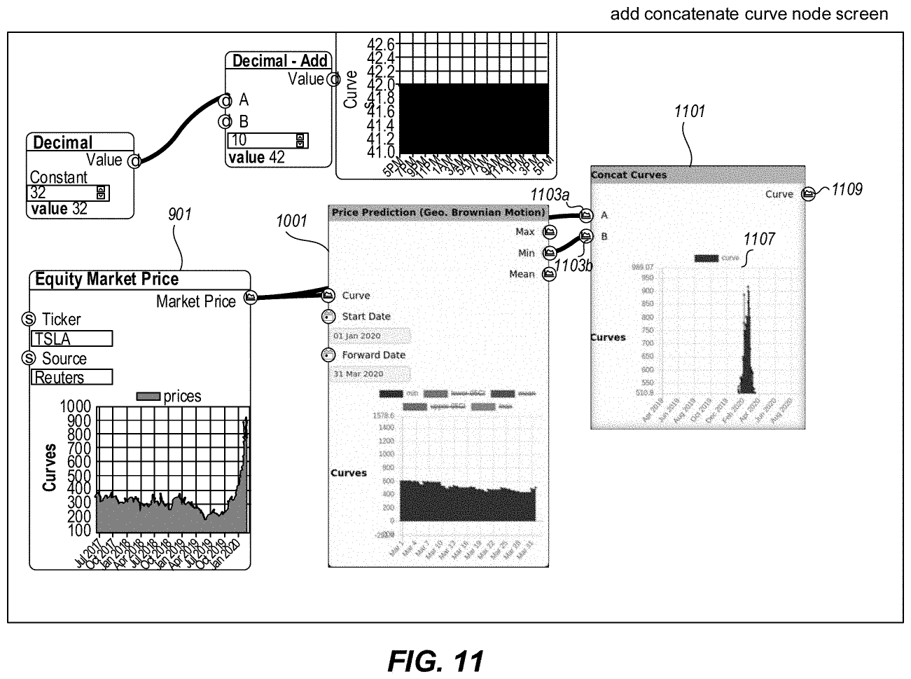

FIG. 11 is a display diagram showing an add concatenate curve node screen, presented by the facility in some embodiments. The add concatenate curve node screen includes a concatenate curve node block 1101, inputs 1103a and 1103b, a graph 1107, and an output 1109. The concatenate curve node block takes two curves as input and outputs a curve which is the concatenation of the two input curves. The input 1103a is obtained from the market price node block 901, and the input 1103b is obtained from the custom node block 1001. As seen in FIG. 11, a node's output can be connected to more than one other nodes, and more than one other inputs. The facility concatenates the curves obtained from inputs 1103a and 1103b to create a new curve. The facility displays this new curve by using the graph 1107. Additionally, the output 1109 outputs this new curve.

Returning to FIG. 3, at act 309, the facility maps the outputs and inputs of the nodes based on the user input connecting the outputs of nodes to inputs of nodes to establish a network among the nodes. At act 311, the facility stores each node in a node data table, such as the node data table 200 described in relation to FIG. 2. At act 313, the facility stores the mapping of outputs and inputs of nodes in a custom software definition table. After act 313 the process ends.

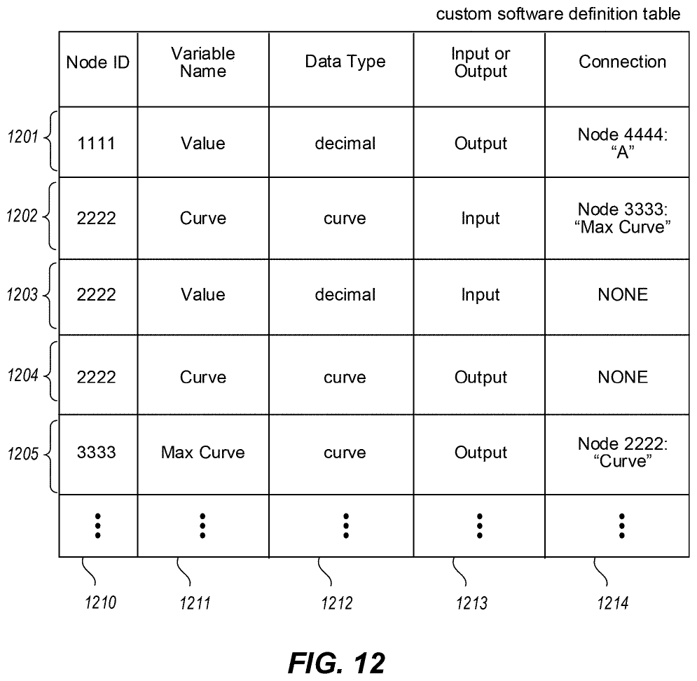

FIG. 12 is a table diagram showing a custom software definition table 1200 used by the facility in some embodiments. The custom software definition table 1200 stores information describing the connections between each of the nodes of a particular network of nodes. The custom software definition table 1200 in FIG. 12 is a partial representation of a custom software definition table used to describe the connections between nodes in a visual graph. The custom software definition table 1200 includes a node id column 1210, a variable name column 1211, a data type column 1212, an input or output column 1213, and a connection column 1214. The node id column 1210 is used to identify a node in a similar manner to the node id column 210 of FIG. 2. The facility uses the variable name column 1211 to identify variables used by the node indicated in the node id column 1210. The data type column 1212 contains information specifying a data type of a variable indicated by the variable name column 1211. The input or output column 1213 contains information specifying whether the variable is used for input into the node or output from the node. The connection column 1214 stores information indicating how the facility should route data related to the variable from one node to another. For example, row 1201 indicates that the “value” variable of node 1111 is a decimal and is an output of node 1111. Additionally, row 1201 indicates that the “Value” variable is connected to the “A” variable of node 4444. In this way, the facility specifies that output from node 1111 is used as input for node 4444. As another example, row 1202 indicates that node 2222's “Curve” variable is a curve, and is an input into node 2222. Row 1202 additionally indicates that node 2222 is connected to node 3333 such that the “Max Curve” variable of node 3333 is used as input for the “Curve” variable of node 2222.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

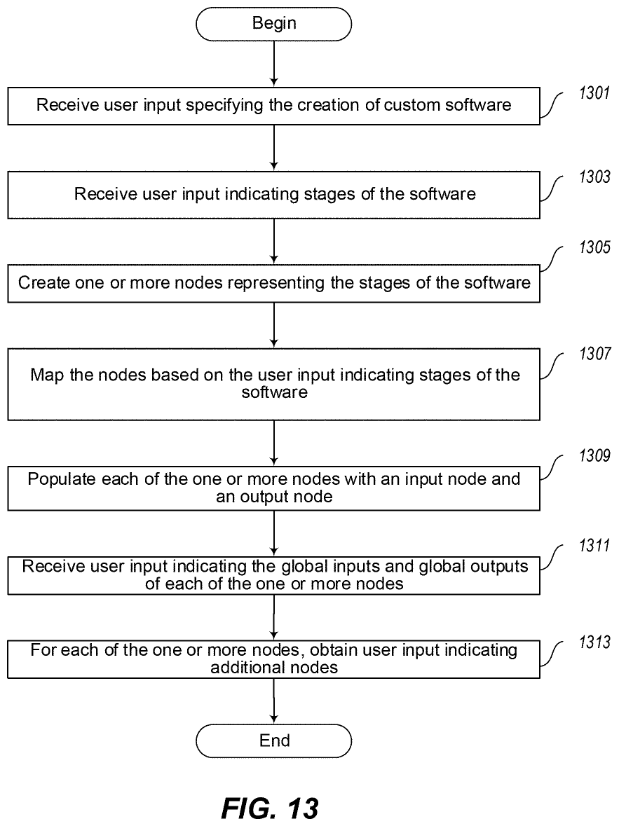

FIG. 13 is a flow diagram showing a process to create custom software with stages, performed by the facility in some embodiments. In act 1301, the facility receives user input specifying the creation of custom software. In act 1303, the facility receives user input indicating stages of the custom software. In some embodiments, the facility performs acts 1301 and 1303 by displaying a custom software definition screen to the user.

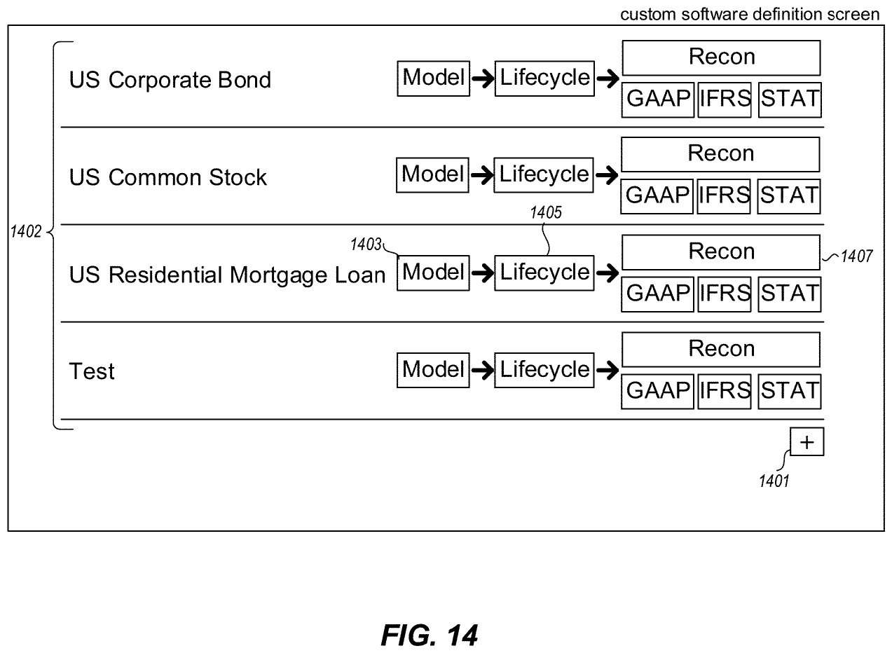

FIGS. 14-20 show a variety of sample screens used by the facility to obtain user input to create custom software. FIG. 14 is a display diagram showing a custom software definition screen, presented by the facility in some embodiments. The custom software definition screen includes a create software button 1401 and software definitions 1402. Each software definition includes multiple stages, including a model stage 1403, a lifecycle stage 1405, and a reconciliation stage 1407. A user creates a new software definition by activating the create software button 1401. The model stage 1403 is used to create a model of the security which is used in later stages. The lifecycle stage 1405 is used to define the state of the security at different stages of its lifecycle. The reconciliation phase 1407 is used to perform analysis regarding the security based on the model and lifecycle. In some embodiments, the facility allows a user to specify additional stages in the software definition. In some embodiments, the facility obtains user input indicating how the stages relate to each other, such as by defining whether a stage should receive another stages output as input.

Returning to FIG. 13, at act 1305 the facility creates one or more nodes representing each of the stages of the software. In some embodiments, the nodes are parent nodes. In some embodiments, the facility additionally creates one or more child nodes for the parent nodes. At act 1307, the facility maps the nodes based on the user input indicating stages of the software. In some embodiments, the facility maps the nodes by routing the outputs of parent nodes representing the stages to inputs of other parent nodes representing the stages. At act 1309, the facility populates each of the nodes with one or more input nodes and one or more output nodes. In some embodiments the input node and output node are child nodes. At act 1311, the facility obtains user input indicating the global inputs and global outputs for each of the nodes representing stages of the software. At act 1313, the facility obtains user input indicating additional child nodes for each of the nodes representing stages of the software. These additional child nodes are used to process the global inputs for each node representing stages of the software to produce the global outputs. In some embodiments, as part of performing acts 1305-1313, the facility displays a custom software diagram screen. After act 1313, the process ends.

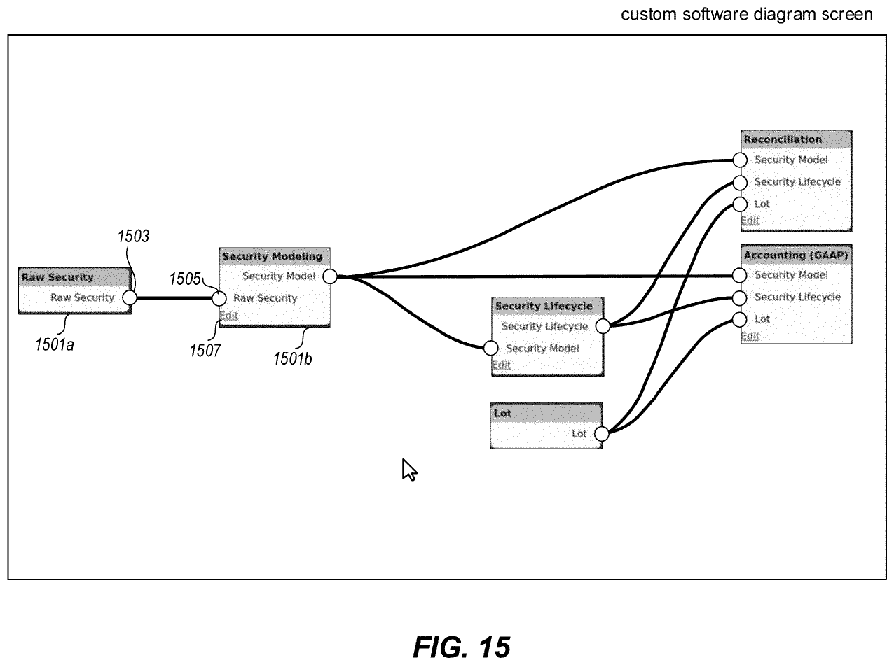

FIG. 15 is a display diagram showing a custom software diagram screen, presented by the facility in some embodiments. The custom software diagram screen includes node blocks 1501a and 1501b. Node block 1501a includes an output 1503. Node block 1501b includes an input 1505 and an edit button 1507. Each of the node blocks 1501 included in the custom software diagram screen represent a stage of the software. The facility executes the custom software by evaluating the node blocks based on their connections with other nodes. For example, node block 1501a performs operations on a raw security, and transmits the output of those operations to the security modeling block (node block 1501b) to process the output and create a security model. When a user activates the edit button 1507, the user can edit the operations performed by the node. In some embodiments the faculty presents an output definition screen when a user activates the edit button 1507.

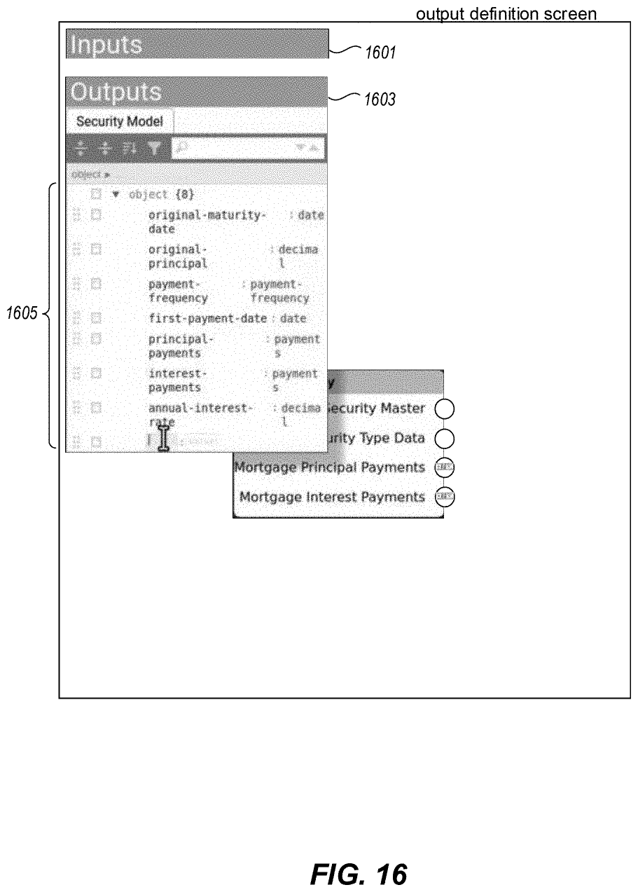

FIG. 16 is a display diagram showing an output definition screen, presented by the facility in some embodiments. The output definitions screen includes a global input menu 1601, a global output menu 1603. The global input menu 1601 and global output menu 1603 allow a user to define the global outputs and global inputs by using an input interface such as the global output definition 1605. The facility uses the global output definition 1605 to obtain user input defining the outputs and their data types for the node representing a stage of the software. In some embodiments, after obtaining the global outputs and global inputs the facility displays an add interface node screen.

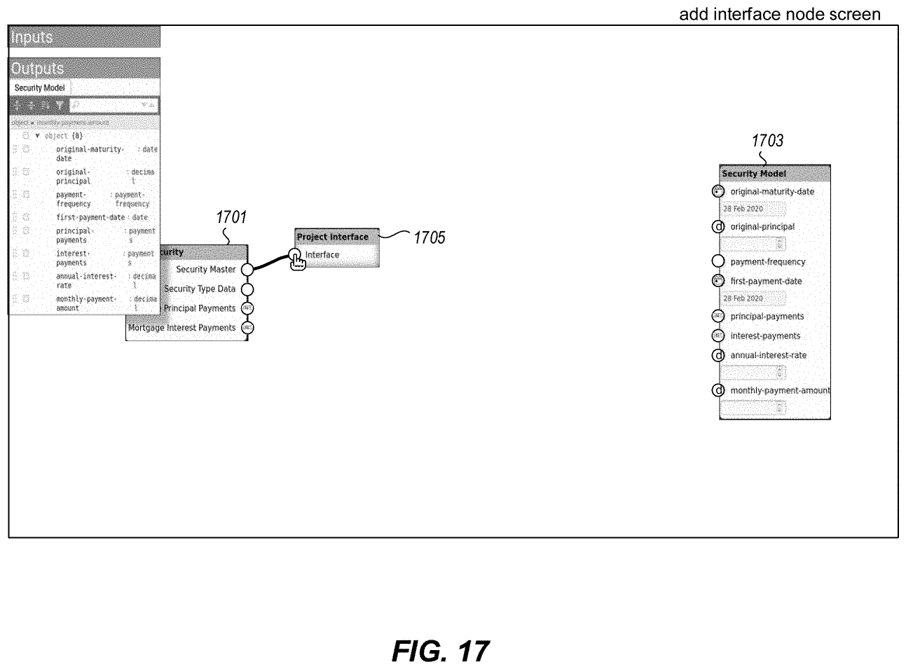

FIG. 17 is a display diagram showing an add interface node screen, presented by the facility in some embodiments. The add interface node screen includes a global input node block 1701, a global output node block 1703, and a project interface node block 1705. The global input node block 1701 acts as a conduit for the global inputs, and can output each of these global inputs to new nodes created by a user. The global output node block1703 represents the global outputs specified by the user, and the node which those outputs are directed to. For example, the global output node block 1703 specifies that the outputs are output to the security model node (which appears as node 1501b in FIG. 15) representing the security model stage of the software. In some embodiments, the facility displays multiple global output node blocks, each representing a different stage of the software. In some embodiments, the global output node block 1703 outputs data to a file, webpage, log, etc. The project interface node block 1705 represents a node configured to obtain one of the global inputs from the global input node block 1701. After the project interface block 1705 is connected to the global input node block 1701, the facility populates the project interface node with all of the data related to the security as potential outputs of the project interface block 1705. In some embodiments, the facility displays a define interface node screen when the project interface node is connected to one of the global inputs.

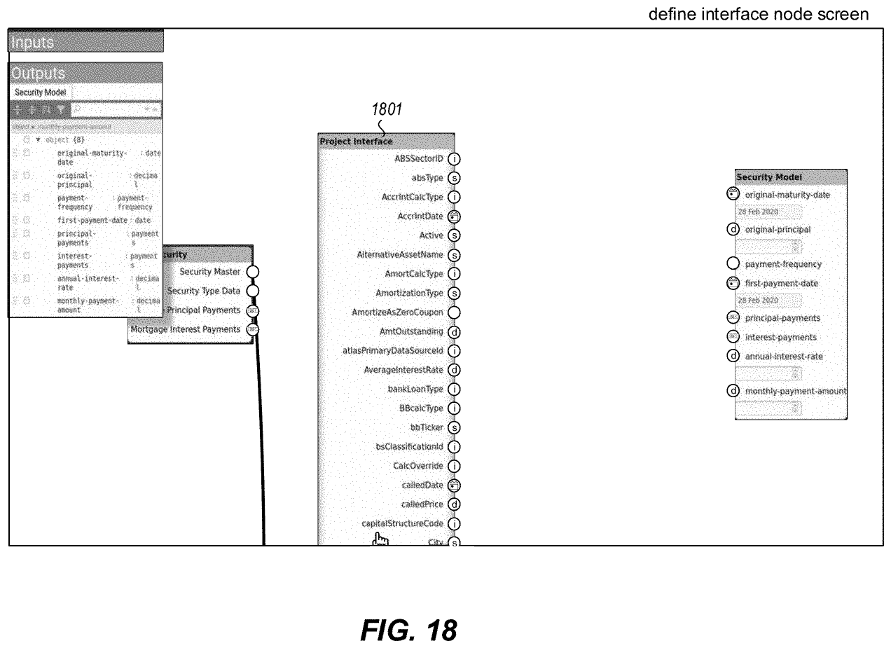

FIG. 18 is a display diagram showing a define interface node screen, presented by the facility in some embodiments. The project interface node screen includes a project interface node block 1801. The project interface node block 1801 represents a project interface node, which includes outputs for a variety of variables used to represent a resource. For example, the project interface node block 1801 represents a project interface node which is connected to the “Security Master” global input. The “Security Master” input represents the all of data used to represent a resource, such as a security. In some embodiments, the facility obtains data to populate the project interface node from a repository of resource data, such as the Security Repository. In this way, a user can access the data and create nodes to format, process, analyze, etc., the data before outputting it to the next stage.

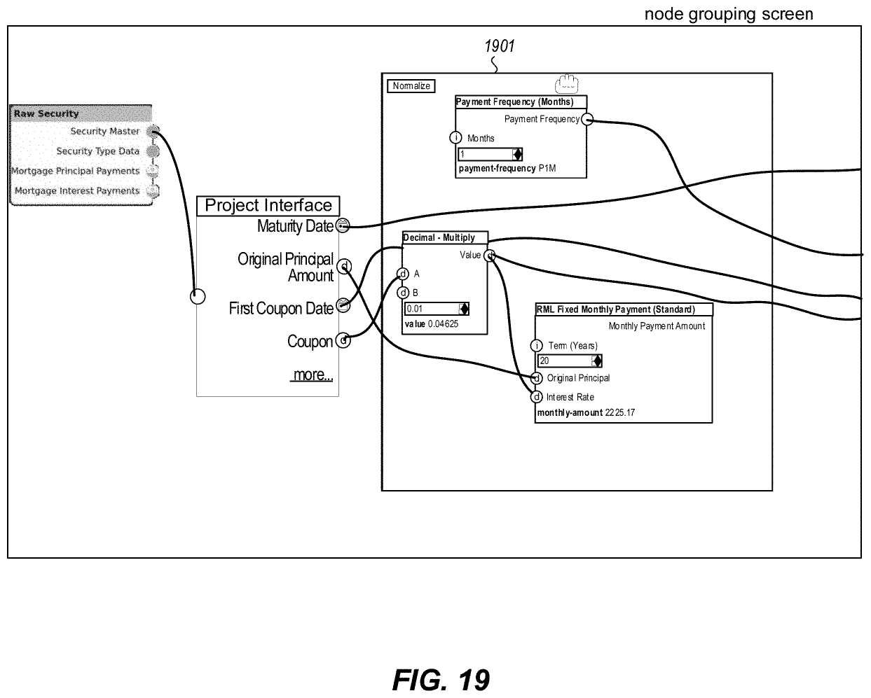

FIG. 19 is a display diagram showing a node grouping screen, presented by the facility in some embodiments. The node grouping screen includes a node group 1901. The facility creates a node group in response to obtaining user input specifying that a plurality of nodes should be group together, such as the nodes in the node group 1901. The node group 1901 is a group of nodes designated by a user as a group. Grouping the nodes allows a user to signal that certain nodes perform certain actions, such as normalizing data, performing analysis on the data, etc. The node group 1901 is an example of a group of nodes used to normalize data obtained from the project interface node, before outputting that data as global outputs.

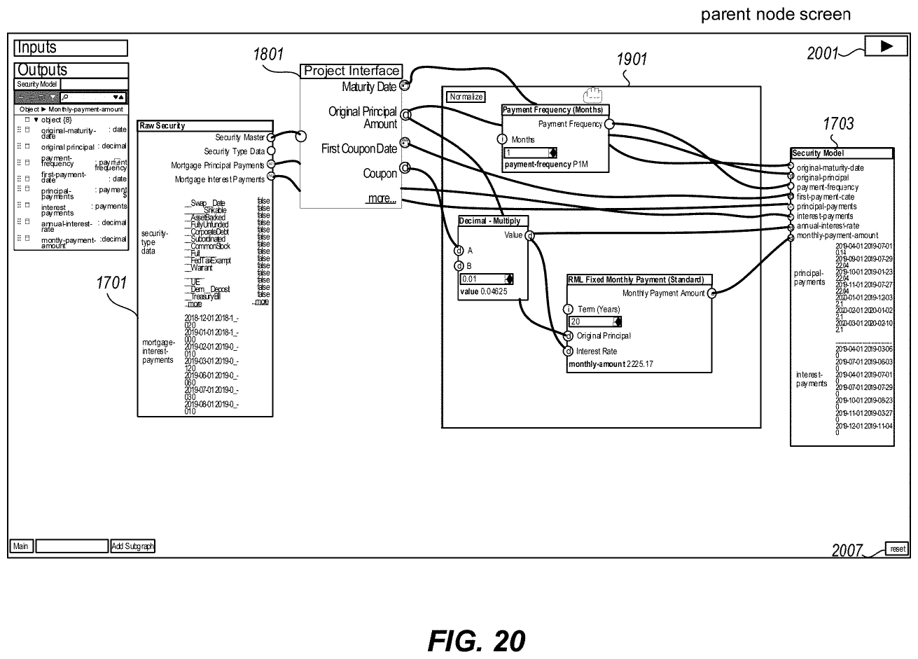

FIG. 20 is a display diagram showing a parent node screen, presented by the facility in some embodiments. The parent node screen includes the nodes and node groups of FIGS. 17-19, as well as a run button 2001 and a reset button 2007. When the run button 2001 is activated, the facility evaluates all of the nodes according to their connections. In some embodiments, the facility displays the output obtained by evaluating each node inside each respective node. In some embodiments, the facility performs the functions when a new node is added, when new connection is established, when new data is obtained, when a data source for a node is changed, etc. When the reset button 2007 is activated, the facility resets the parent node to include only the global input node block 1701 and the global output node block 1703.

FIG. 21 is a flow diagram showing a process to create custom nodes, used by the facility in some embodiments. At act 2101, the facility receives user input specifying the creation of a custom node. At act 2103, the facility obtains a code function specifying the operation of the custom node. In some embodiments, the facility analyzes the code function to determine outputs and inputs for the code function. In some embodiments, a user specifies the outputs and inputs for the code function. At act 2105, the facility stores the code function and the custom node, such that the facility uses the code function to evaluate the custom node. In some embodiments, the code function is defined by using a programming language, such as C, C++, C#, Java, Python, Ruby, JavaScript, ActionScript, etc. In some embodiments, the programming language used to define the code function does not need to match the programming language in which the facility is defined. In some embodiments, the code function is defined by using one or more nodes.

The various embodiments described above can be combined to provide further embodiments. All of the U.S. patents, U.S. patent application publications, U.S. patent applications, foreign patents, foreign patent applications and non- patent publications referred to in this specification and/or listed in the Application Data Sheet are incorporated herein by reference, in their entirety. Aspects of the embodiments can be modified, if necessary, to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. One or more instances of computer-readable media collectively having contents configured to cause a computing device to perform a method for creating custom software to analyze resource data, the method comprising:
obtaining user input indicating one or more global inputs and one or more global outputs;
obtaining user input creating one or more nodes, each node having one or more inputs and one or more outputs, each node configured to evaluate resource data based on the one or more inputs to produce the one or more outputs;
obtaining user input mapping between outputs and inputs of nodes to establish a network among the nodes; and
evaluating each of the nodes in accordance with the established network based on the one or more global inputs to obtain the one or more global outputs.

2. The one or more instances of computer-readable media of claim 1, the method further comprising:
obtaining user input specifying a source for the resource data.

3. The one or more instances of computer-readable media of claim 1, wherein at least one of one or more inputs of one node of the one or more nodes is obtained from the resource data.

4. The one or more instances of computer-readable media of claim 2, further comprising:
determining whether the resource data or the source of the resource data has changed; and
for each node of the one or more nodes:
determining whether at least one of the one or more inputs has changed;
evaluating the node to obtain the one or more outputs based on the determination that at least one of the one or more inputs, the source of the resource data, or the resource data, has changed; and
displaying the one or more outputs.

5. The one or more instances of computer-readable media of claim 1, further comprising:
obtaining user input specifying that at least one of the one or more nodes is a parent node containing a second set of one or more nodes; and
evaluating the parent node by evaluating the nodes of the second set to obtain the one or more outputs based on the second set of one or more nodes and the one or more inputs.

6. The one or more instances of computer-readable media of claim 1, wherein at least one of the one or more inputs, the one or more outputs, and the resource data comprises time-series data.

7. The one or more instances of computer-readable media of claim 1, wherein at least one of the one or more inputs, the one or more outputs, and the resource data comprises one or more curves.

8. The one or more instances of computer-readable media of claim 1, wherein the method further comprises:
receiving, via user input, code representing instructions to evaluate inputs and return outputs; and
generating a custom node based on the received code.

9. The one or more instances of computer-readable media of claim 1, wherein the mapping between outputs and inputs of nodes is performed automatically based on a data type of each of the inputs and a data type of each of the outputs.

10. The one or more instances of computer-readable media of claim 1, wherein the method further comprises:
displaying the nodes and the network among the nodes; and
displaying a result of evaluating each of the nodes.

11. A system for creating custom software to analyze resource data, the system comprising:
a computing device configured to display nodes, node connections, and resource data;
the computing device being further configured to:
obtain user input indicating one or more global inputs and one or more global outputs;
obtain user input creating one or more nodes, each node having one or more inputs and one or more outputs, each node configured to evaluate resource data based on the one or more inputs to produce the one or more outputs;
obtain user input mapping between outputs and inputs of nodes to establish a network among the nodes; and
evaluate each of the nodes in accordance with the established network based on the one or more global inputs to obtain the one or more global outputs.

12. The system of claim 11, wherein the computing device is further configured to obtain user input specifying a source for the resource data.

13. The system of claim 11, wherein the computing device is further configured to:
determine whether the resource data or the source of the resource data has changed; and
for each node of the one or more nodes:
determine whether at least one of the one or more inputs has changed;
evaluate the node to obtain the one or more outputs based on the determination that at least one of the one or more inputs, the source of the resource data, or the resource data, has changed; and
display the one or more outputs.

14. The system of claim 11, wherein the computing device is further configured to:
obtain user input indicating that at least one of the one or more nodes is a parent node containing a second set of one or more nodes; and
evaluate the parent node by evaluating the nodes of the second set to obtain the one or more outputs based on the second set of one or more nodes and the one or more inputs.

15. The system of claim 11, wherein at least one of the one or more inputs, the one or more outputs, and the resource data comprises time-series data.

16. The system of claim 11, wherein at least one of the one or more inputs, the one or more outputs, and the resource data comprises curves.

17. The system of claim 11, wherein the computing device is further configured to:
receive, via user input, code representing instructions to evaluate inputs and return outputs; and
generate a custom node based on the received code.

18. The system of claim 11, wherein the computing device is further configured to map between outputs and inputs of nodes is performed automatically based on a data type of each of the inputs and a data type of each of the outputs.

19. The system of claim 11, wherein the computing device is further configured to:
display the nodes and the network among nodes; and
display a result of evaluating each of the nodes.

20. One or more storage devices collectively storing a custom software data structure, the data structure comprising:
information specifying one or more global inputs;
information specifying one or more global outputs;
information specifying one or more node data structures, wherein each node data structure includes information specifying:
one or more inputs;
one or more outputs; and
a list containing one or more input node connections used to obtain input data; and
a list containing one or more output node connections used to output data; and
information specifying resource data,
such that the contents of the data structure are usable to cause a computing device to obtain the one or more global outputs by evaluating each of the nodes based on the one or more global inputs and the resource data.

21. The one or more storage devices of claim 20, wherein the data structure further comprises information specifying a data source for the resource data.

22. The one or more storage devices of claim 20, wherein information specifying a node data structure further includes:
information specifying one or more parent node data structures, the parent node data structures including:
a list containing one or more child nodes, the child nodes comprising a node data structure.

23. The one or more storage devices of claim 20, wherein the resource data further comprises time-series data.

24. The one or more storage devices of claim 20, wherein the resource data further comprises curves

25. The one or more storage devices of claim 20, wherein the node data structure further includes information specifying code representing instructions to evaluate inputs.

26. The one or more storage devices of claim 20 wherein the node data structure further includes a node type.
